(19) United States
(12) Patent Application Publication
(10) Pub. No.: US 2020/0181340 A1
(43) Pub. Date: Jun. 11, 2020

(54) FIBER-REINFORCED RESIN COMPOSITION, RESIN MOLDED PRODUCT CONTAINING THE SAME, ELECTROPHOTOGRAPH FORMING APPARATUS, AND EXTERIOR COMPONENT FOR ELECTROPHOTOGRAPH FORMING APPARATUS

(71) Applicant: Konica Minolta, Inc., Tokyo (JP)

(72) Inventor: Yohei SHINOHARA, Okazaki-shi (JP)

(21) Appl. No.: 16/682,694

(22) Filed: Nov. 13, 2019

(30) Foreign Application Priority Data
Dec. 11, 2018 (JP) 2018-231536

(51) Int. Cl. C08J 5/04; G03G 15/00; C08L 23/12

(52) U.S. Cl. CPC C08J 5/045; G03G 15/6502; C08L 2205/16; C08J 2323/12; C08J 2497/00; C08L 23/12

(57) ABSTRACT

A fiber-reinforced resin composition contains a resin and plant fibers dispersed in the resin. At least a part of the resin is in direct contact with at least a part of a surface of the plant fibers. Relation among σr, σrf, and σf satisfies σr<σrf<σf where σr represents tensile strength of the resin, σrf represents interfacial shear stress between the resin and the plant fibers, and σf represents tensile strength of the plant fibers.

The entire disclosure of Japanese Patent Application No. 2018-231536 filed on Dec. 11, 2018 is incorporated herein by reference in its entirety.

### BACKGROUND

### Technological Field

The present invention relates to a fiber-reinforced resin composition, a resin molded product containing the same, an electrophotograph forming apparatus, and an exterior component for an electrophotograph forming apparatus.

### Description of the Related Art

A fiber-reinforced resin composition is not only light in weight but also excellent in mechanical strength such as tensile strength. Therefore, the fiber-reinforced resin composition has been known as a material that can be used for interior and exterior components of vehicles, marine vessels, and rail vehicles, housing equipment, and office equipment and has conventionally been used for various purposes. Among fiber-reinforced resin compositions, a resin composition reinforced with natural fibers, that has improved mechanical characteristics by making a composite of a resin and fibers derived from natural products such as animals and plants (natural fibers), has been proposed as part of biomass utilization. The resin composition reinforced with natural fibers has been considered as generally having improved rigidity but being lower in impact resistance. Therefore, use of the resin composition reinforced with natural fibers as a material for the interior and exterior components, the housing equipment, and the office equipment described above has been considered as being difficult in a portion where external impact is applied.

In order to address this, for example, Japanese Laid-Open Patent Publication No. 2011-126987 discloses a natural fiber reinforced biodegradable resin composite material having improved impact resistance by adding silk fibers to a biodegradable resin as a reinforcing agent. Japanese Laid-Open Patent Publication No. 2008-208194 discloses a resin composite material having improved impact resistance by providing strength to plant fibers by treating a surface of the plant fibers with a silanol condensate and adding the plant fibers to a resin.

The composite material in Japanese Laid-Open Patent Publication No. 2011-126987 is disadvantageous in difficulty in widespread use thereof because of high cost of silk fibers used as a source material. Since silk fibers are poor in heat resistance, widespread use of the composite material is difficult also in the sense of significant limitation on a resin for making a composite. The resin composite material in Japanese Laid-Open Patent Publication No. 2008-208194 requires a process for spreading cellulose fibers representing plant fibers for treating surfaces thereof with a silanol condensate, and it is disadvantageous in complicatedness and increase in manufacturing cost. Therefore, a fiber-reinforced resin composition that can be obtained inexpensively and has improved impact resistance has not yet been developed.

### SUMMARY

Under the circumstances, an object of the present invention is to provide a fiber-reinforced resin composition that can be obtained inexpensively and has improved impact resistance, a resin molded product containing the same, an electrophotograph forming apparatus, and an exterior component for an electrophotograph forming apparatus.

During the course of development of a fiber-reinforced resin composition that can be obtained inexpensively and has improved impact resistance, the present inventors initially have focused on obtaining an inexpensive fiber-reinforced resin composition by using various plant fibers and resins that are inexpensively available. Then, the present inventors have conducted dedicated studies about providing impact resistance to such a fiber-reinforced resin composition. Consequently, the present inventors have found that impact resistance can be improved as compared with a composition not containing plant fibers but consisting of a resin by setting the sum of fracture energy corresponding to tensile strength of the resin itself and energy corresponding to friction force generated between the plant fibers and the resin (a value calculated by multiplying interfacial shear stress by a longitudinal length of the plant fibers) as energy required by the time of break of the fiber-reinforced resin composition (magnitude of external impact). Based on this finding, the present inventors have found that, when fracture energy of a resin, interfacial shear stress between plant fibers and the resin, and fracture energy of the plant fibers satisfy certain relation, a fiber-reinforced resin composition is improved in impact resistance as compared with a composition consisting of a resin, regardless of a type of the resin and the plant fibers that make up the fiber-reinforced resin composition, and completed the present invention.

To achieve at least one of the abovementioned objects, according to an aspect of the present invention, a fiber-reinforced resin composition reflecting one aspect of the present invention comprises a resin and plant fibers dispersed in the resin. At least a part of the resin is in direct contact with at least a part of a surface of the plant fibers. σr, σrf, and of satisfy relation expressed in an expression (1)

σr<σrf<σf (1)

where σr represents tensile strength of the resin, σrf represents interfacial shear stress between the resin and the plant fibers, and σf represents tensile strength of the plant fibers.

To achieve at least one of the abovementioned objects, according to an aspect of the present invention, a resin molded product reflecting one aspect of the present invention comprises the fiber-reinforced resin composition.

To achieve at least one of the abovementioned objects, according to an aspect of the present invention, an electrophotograph forming apparatus reflecting one aspect of the present invention comprises the resin molded product.

To achieve at least one of the abovementioned objects, according to an aspect of the present invention, an exterior component for an electrophotograph forming apparatus reflecting one aspect of the present invention comprises the resin molded product.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1A illustrates, together with FIGS. 1B, 1C, and 1D, a fiber-reinforced resin composition in the present embodiment satisfying relation expressed in an expression “σr<σrf<σf” by showing change over time when external impact is applied to the fiber-reinforced resin composition.

FIG. 1B illustrates, together with FIGS. 1A, 1C, and 1D, the fiber-reinforced resin composition in the present embodiment satisfying relation expressed in the expression “σr<σrf<σf” by showing change over time when external impact is applied to the fiber-reinforced resin composition.

FIG. 1C illustrates, together with FIGS. 1A, 1B, and 1D, the fiber-reinforced resin composition in the present embodiment satisfying relation expressed in the expression “σr<σrf<σf” by showing change over time when external impact is applied to the fiber-reinforced resin composition.

FIG. 1D illustrates, together with FIGS. 1A, 1B, and 1C, the fiber-reinforced resin composition in the present embodiment satisfying relation expressed in the expression “σr<σrf<σf” by showing change over time when external impact is applied to the fiber-reinforced resin composition.

FIG. 2 is a perspective view showing an exemplary electrophotograph forming apparatus in the present embodiment.

FIG. 3 is a perspective view showing a housing as an exemplary electrophotograph forming apparatus exterior component in the present embodiment.

FIG. 4A illustrates, together with FIG. 4B, an exemplary snap fit structure of the electrophotograph forming apparatus exterior component in the present embodiment.

FIG. 4B illustrates, together with FIG. 4A, the exemplary snap fit structure of the electrophotograph forming apparatus exterior component in the present embodiment.

FIG. 5 is a perspective view showing a paper feed cassette representing an exemplary electrophotograph forming apparatus exterior component in the present embodiment.

FIG. 6 is a perspective view showing a support component representing an exemplary electrophotograph forming apparatus exterior component in the present embodiment.

### DETAILED DESCRIPTION OF EMBODIMENTS

Hereinafter, one or more embodiments of the present invention will be described with reference to the drawings. However, the scope of the invention is not limited to the disclosed embodiments.

Though an embodiment according to the present invention will be described below in further detail, the present invention is not limited to the embodiment. In the description of the embodiment below with reference to the drawings, the same or corresponding elements have the same reference characters allotted.

An expression in a format “A to B” herein means the upper limit and the lower limit of a range (that is, not smaller than A and not greater than B). When a unit is not given for A but a unit is given only for B, A and B are common in unit.

[Fiber-Reinforced Resin Composition]

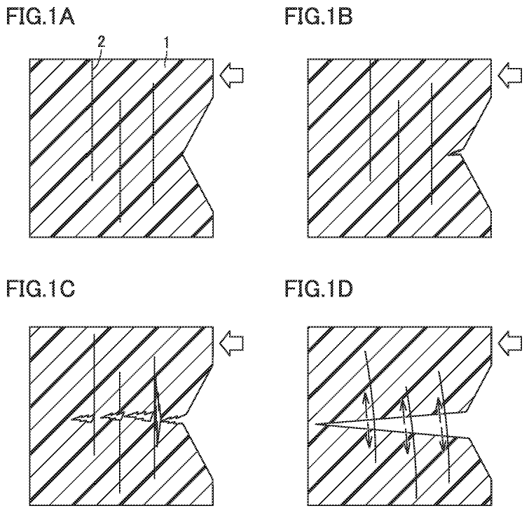

A fiber-reinforced resin composition according to the present embodiment contains a resin 1 and plant fibers 2 dispersed in resin 1 as shown, for example, in FIG. 1A. At least a part of resin 1 is in direct contact with at least a part of a surface of plant fibers 2. The fiber-reinforced resin composition satisfies relation expressed in an expression (1)

σr<σrf<σf (1)

where or represents tensile strength of resin 1, σrf represents interfacial shear stress between resin 1 and plant fibers 2, and σf represents tensile strength of plant fibers 2.

Such a fiber-reinforced resin composition can have improved impact resistance as compared with a composition not containing plant fibers 2 but consisting of resin 1. In particular, the fiber-reinforced resin composition can have improved impact resistance as compared with a composition not containing plant fibers 2 but consisting of resin 1 so long as it satisfies relation expressed in the expression (1) regardless of a type of resin 1 and plant fibers 2 that make up the fiber-reinforced resin composition.

<Resin>

The fiber-reinforced resin composition contains resin 1 and plant fibers 2 dispersed in resin 1 as described above. All types of resins represented by conventionally known thermoplastic resins and thermosetting resins can be employed as resin 1 so long as tensile strength thereof satisfies relation expressed in the expression (1) and an effect of the present invention is achieved. Among these, a thermoplastic resin is preferably adopted as resin 1. With the resin being combined with plant fibers 2, a fiber-reinforced resin composition that satisfies relation expressed in the expression (1) can thus readily be obtained. Similarly from a point of view of readily obtaining a fiber-reinforced resin composition, resin 1 preferably has both or any one of a glass transition temperature and a melting point not higher than a decomposition start temperature of plant fibers 2.

The “resin having both or any one of a glass transition temperature and a melting point not higher than a decomposition start temperature of the plant fibers” means that, regarding a resin and plant fibers that make up a fiber-reinforced resin composition, when the resin has both of a glass transition temperature and a melting point as in a case, for example, of polypropylene (PP), polyethylene terephthalate (PET), or polycarbonate (PC), the plant fibers have a decomposition start temperature equal to or lower than both of the points, and that when the resin has only one of the glass transition temperature and the melting point as in a case, for example, of polystyrene (PS) or polymethyl methacrylate (PMMA), the plant fibers have a decomposition start temperature equal to or lower than one of the points. PS and PMMA have only a glass transition temperature.

When both or any one of a glass transition temperature and a melting point of a resin are/is equal to or lower than a decomposition start temperature of plant fibers, the plant fibers can be added to the resin without being decomposed. Therefore, tensile strength (σf) of the plant fibers in the fiber-reinforced resin composition can be expected to be maintained at a value before addition of the plant fibers to the resin. A fiber-reinforced resin composition that satisfies relation expressed in the expression (1) can thus readily be obtained.

As described above, in the present embodiment, so long as tensile strength satisfies relation expressed in the expression (1) and the effect of the present invention is achieved, all conventionally known resins represented by a thermoplastic resin and a thermosetting resin can be employed as the resin. Among these, a thermoplastic resin is preferably employed as the resin. Specifically, for example, polyolefin (such as polypropylene or polyethylene), aliphatic and aromatic polyester resins (an aliphatic polyester resin such as polylactic acid, polycaprolactone, or polybutylene succinate and an aromatic polyester resin such as polyethylene terephthalate, polybutylene terephthalate, or polytrimethylene terephthalate), polystyrene, an acrylic resin (a resin obtained by using both or any one of methacrylate and acrylate), a polyamide resin (such as nylon), a polycarbonate resin, a polyacetal resin, and an ABS resin are preferably employed. One of the thermoplastic resins alone or two or more types thereof as being combined may be used.

A composition of a resin that makes up the fiber-reinforced resin composition can be identified by analysis, for example, by using a Fourier transform infrared spectrophotometer (FT-IR).

<Plant Fibers>

As described above, the fiber-reinforced resin composition contains resin 1 and plant fibers 2 dispersed in resin 1. The “plant fiber” herein refers to a fiber derived from a plant and to a linear body in which a plurality of polymer chains are intertwined to make up a bundle. Therefore, the “surface” of the plant fiber refers to an exposed surface on an outer side of polymer chains located at an outermost surface in a linear body composed of a plurality of polymer chains that make up the plant fiber.

All conventionally known types of plant fibers can be employed as plant fibers 2 so long as tensile strength thereof satisfies relation expressed in the expression (1) and the effect of the present invention is achieved. Any of plant fibers 2 categorized, for example, into plant-derived natural fibers, regenerated fibers, and purified cellulose fibers can be employed so long as tensile strength thereof satisfies relation expressed in the expression (1) and the effect of the present invention is achieved.

Specifically, examples of plant-derived natural fibers include fibers of cotton, kenaf, jute, abaca, sisal, Wikstroemia sikokiana, Edgeworthia chrysantha, paper mulberry, banana, pineapple, coconut palm, corn, sugar cane, bagasse, palm, papyrus, reed, esparto, sabai grass, barley and/or wheat, rice plant, and bamboo. Examples of regenerated fibers include fibers of rayon, polynosic, cupra, and nitrocellulose. Examples of purified cellulose fibers include fibers of Tencel™ and lyocell. One type of these fibers alone or two or more types thereof as being combined may be used.

The plant fiber refers to a linear body in which a plurality of polymer chains are intertwined to make up a bundle as described above. In particular, in the present embodiment, the plant fiber refers to a fiber having a cross-sectional size not smaller than 1 μm in a direction perpendicular to a longitudinal direction thereof (which is also denoted as a “fiber diameter” below). Plant fibers preferably have an average fiber diameter, for example, from 1 to 100 μm and an average longitudinal length from 10 μm to 20 mm. Plant fibers 2 further preferably have an average fiber diameter from 1 to 20 μm and an average longitudinal length from 500 μm to 10 mm. When plant fibers 2 have an average fiber diameter and an average longitudinal length within the ranges described above, a fiber-reinforced resin composition satisfying relation expressed in the expression (1) can more readily be obtained.

The fiber-reinforced resin composition contains preferably at least 0.1 mass % and at most 50 mass % of plant fibers. The fiber-reinforced resin composition contains more preferably at least 0.5 mass % and at most 50 mass % and particularly preferably at least 1 mass % and at most 30 mass % of plant fibers. When a ratio of plant fibers contained in the fiber-reinforced resin composition is within the range described above as well, a fiber-reinforced resin composition satisfying relation expressed in the expression (1) can more readily be obtained.

A type of the plant fibers that make up the fiber-reinforced resin composition can be identified, for example, by combining a Fourier transform infrared spectrophotometer (FT-IR) with morphological observation by using a microscope.

An average fiber diameter and an average longitudinal length of plant fibers can be determined by fixing a plant fiber onto a substrate such as a preparation, obtaining image data by observing the plant fiber with an optical microscope, and making measurement based on the image data. For calculation of an average fiber diameter and an average longitudinal length, at least one hundred plant fibers are preferably subjected to measurement. Specifically, plant fibers are taken by manufacturing a molded product in an arbitrary shape from a fiber-reinforced resin composition and separating the molded product into plant fibers and a resin, for example, by using such an organic solvent as methanol or ortho-dichlorobenzene. By using the above-described method for the plant fibers, an average fiber diameter and an average longitudinal length thereof can be determined.

<Positional Relation Between Resin and Plant Fibers in Fiber-Reinforced Resin Composition>

In the fiber-reinforced resin composition according to the present embodiment, at least a part of resin 1 is in direct contact with at least a part of a surface of plant fibers 2. Specifically, at least a part of polymer chains of resin 1 randomly arranged in the fiber-reinforced resin composition is in direct contact with at least a part of the surface of plant fibers 2. Thus, when external impact is applied to the fiber-reinforced resin composition, friction force between resin 1 and plant fibers 2 (energy corresponding to a value calculated by multiplying interfacial shear stress (σrf) between resin 1 and plant fibers 2 by a longitudinal length of the plant fibers) can act as will be described later and hence impact resistance of the fiber-reinforced resin composition can be improved.

In the fiber-reinforced resin composition, at least a part of resin 1 is in direct contact with at least a part of the surface of plant fibers 2 as described above. Therefore, so long as the effect of the present invention is achieved, an additive added to the fiber-reinforced resin composition may be present between the surface of plant fibers 2 and resin 1. Furthermore, a gap may be present between the surface of plant fibers 2 and resin 1.

A content of the additive added to the fiber-reinforced resin composition is not restricted so long as the effect of the present invention is not impaired. Exemplary types of the additive include a reinforcing material, a filler (glass fibers, carbon fibers, organic fibers, metal fibers, natural fibers, ceramic fibers, wollastonite, potassium titanate, sepiolite, asbestos, talc, mica, sericite, kaolin, glass flakes, milled glass, glass beads, ceramic beads, calcium carbonate, silica, alumina, or clay), a flame retardant (based on bromine, phosphorus, inorganic hydroxide, a nitrogen-containing component, silicone, or sulfuric acid), an ultraviolet absorbent (based on benzophenone, benzotriazole, salicylate, or resorcinol), a thermal stabilizer (based on hindered phenol or phosphite-based hydroquinone), a lubricant (based on hydrocarbon, fatty acid, fatty acid ester, aliphatic alcohol, aliphatic amide, or aliphatic metallic soap), a plasticizer (based on polyester, glycerol, polyvalent carboxylic acid ester, polyalkylene glycol, epoxy, or castor oil), a pigment (carbon black, titanium oxide, cadmium sulfide, or phthalocyanine), an anti-drip agent (polytetrafluoroethylene (PTFE) or the like), a silane coupling agent (alkoxy silane, vinyl-, amino-, or epoxy-based), an acid anhydride compound (maleic anhydride, succinic anhydride, or a polymer compound obtained by grafting or copolymerizing an acid anhydride), a crystal nucleating agent, an antioxidant, a lightfast agent, a weather resistant agent, an antistatic agent, and a conductor material.

At least a part of resin 1 being in direct contact with at least a part of the surface of plant fibers 2 in the fiber-reinforced resin composition can be confirmed by a method below. A molded product in a shape of a parallelepiped is manufactured from the fiber-reinforced resin composition and a cross-sectional sample having a cut plane obtained by cutting the molded product in a direction perpendicular to the surface of the molded product is obtained. Then, the direct contact can be confirmed by observing the cross-sectional sample with a scanning electron microscope (SEM, a trademark “S-4800” manufactured by Hitachi High-Technologies Corporation).

<Relation Between Impact Resistance and Expression (1)>

The fiber-reinforced resin composition according to the present embodiment satisfies relation expressed in the expression (1)

σr<σrf<σf (1)

where σr represents tensile strength of resin 1, σrf represents interfacial shear stress between resin 1 and plant fibers 2, and σf represents tensile strength of plant fibers 2 as described above.

The reason why the fiber-reinforced resin composition is improved in impact resistance as compared with a composition not containing plant fibers 2 but consisting of resin 1 when the fiber-reinforced resin composition satisfies relation in the expression (1) will be described below with reference to FIGS. 1A, 1B, 1C, and 1D.

Initially, in the expression (1), tensile strength (σf) of plant fibers 2 is higher than tensile strength (σr) of resin 1 and higher than interfacial shear stress (σrf) between resin 1 and plant fibers 2. In this case, the fiber-reinforced resin composition shown in FIG. 1A requires energy corresponding to the sum of fracture energy of resin 1 and friction force between resin 1 and plant fibers 2 by the time of break by external impact (stress), which will be described with reference to the figures. In the fiber-reinforced resin composition, a crack is initially generated in resin 1 as shown in FIG. 1B by the time of break by external impact (stress). Then, as shown in FIG. 1C, a crack is generated in an interface between resin 1 and plant fibers 2, and finally as shown in FIG. 1D, break shown with a double-headed arrow extending along the longitudinal direction of plant fibers 2 occurs in resin 1.

In FIGS. 1A, 1B, 1C, and 1D, the crack in resin 1 in FIG. 1B represents fracture energy of resin 1. The crack generated in the interface between resin 1 and plant fibers 2 in FIG. 1C and the double-headed arrow extending in the longitudinal direction of plant fibers 2 in FIG. 1D represent energy corresponding to friction force between resin 1 and plant fibers 2. The friction force is equivalent to energy corresponding to a value calculated by multiplying interfacial shear stress (ad) between resin 1 and plant fibers 2 by a longitudinal length of the plant fibers.

Thus, break of the fiber-reinforced resin composition by external impact (stress) requires energy corresponding to the sum of fracture energy of resin 1 and friction force between resin 1 and plant fibers 2 as represented by the crack in FIGS. 1B and 1C and the arrow in FIG. 1D. In contrast, energy required for break of a composition consisting of resin 1 by external impact (stress) is only fracture energy of resin 1. Therefore, the fiber-reinforced resin composition can be improved in impact resistance as compared with the composition consisting of resin 1.

In particular, in the expression (1), tensile strength (σf) of plant fibers 2 is higher than interfacial shear stress (σrf) between resin 1 and plant fibers 2. Thus, in the fiber-reinforced resin composition, plant fibers 2 do not break before friction force between resin 1 and plant fibers 2 acts. As tensile strength (σf) of plant fibers 2 is higher than tensile strength (σr) of resin 1, plant fibers 2 do not break before break of resin 1 either. As interfacial shear stress (σrf) between resin 1 and plant fibers 2 is higher than tensile strength (σr) of resin 1, break of the fiber-reinforced resin composition by external impact (stress) requires energy corresponding to the sum of fracture energy of resin 1 and friction force between resin 1 and plant fibers 2 without exception.

As set forth above, when relation in the expression (1) is satisfied, the fiber-reinforced resin composition can have improved impact resistance as compared with the composition not containing plant fibers 2 but consisting of resin 1.

<Function>

According to the present embodiment, so long as σr, σrf, and of satisfy relation of σr<σrf<σf where or represents tensile strength of a resin, σrf represents interfacial shear stress between the resin and plant fibers, and σf represents tensile strength of the plant fibers, regardless of a type of the resin and the plant fibers, a fiber-reinforced resin composition improved in impact resistance as compared with a composition not containing the plant fibers but consisting of the resin can be provided.

<Method of Manufacturing Fiber-Reinforced Resin Composition>

The fiber-reinforced resin composition according to the present embodiment can be manufactured by a conventionally known method of manufacturing a resin composition except for addition of plant fibers, without being particularly restricted. The fiber-reinforced resin composition can be manufactured, for example, by performing steps of obtaining a mixture by mixing and agitating components described above (a resin and plant fibers) and an additive such as a stabilizer to be added as necessary (a mixing step) and obtaining a fiber-reinforced resin composition by melting and mixing and kneading the mixture (an injection molding step).

(Mixing Step)

A conventionally known method can be employed as the method of mixing and agitation in the mixing step. In the mixing step, a mixture can be obtained by mixing and agitation, for example, by using a Henschel® Mixer (a trademark “FM-MIXER” manufactured by Nippon Coke & Engineering Co., Ltd.) in accordance with a dry blending method. In this case, only one type alone or two or more types as being combined of each of the resin and the plant fibers may be employed.

(Injection Molding Step)

An apparatus to be used in the injection molding step is not particularly limited, and an appropriate apparatus is preferably selected depending on an aimed resin molded product and a property thereof or a type of a thermoplastic resin used. A fiber-reinforced resin composition can be obtained, for example, by using an injection molding machine (a trademark “J110AD” manufactured by The Japan Steel Work, Ltd.), introducing the mixture into a cylinder in the injection molding machine, and melting and mixing and kneading the mixture. A temperature of the cylinder in the injection molding machine is preferably set to a temperature equal to or lower than a decomposition start temperature of the plant fibers and higher than both or any one of a glass transition temperature and a melting point of the resin. The temperature of the cylinder is preferably controlled to a temperature at which decomposition of the plant fibers can be suppressed and fluidity of the resin can be secured depending on a type of the plant fibers and the resin to be molten and mixed and kneaded.

[Resin Molded Product]

The resin molded product according to the present embodiment contains the fiber-reinforced resin composition. Such a resin molded product can have improved impact resistance as compared with a resin molded product consisting of a resin that makes up the fiber-reinforced resin composition.

<Molded Product in Shape of Parallelepiped>

When a resin molded product is molded in a shape of a parallelepiped, at least one of plant fibers has a longitudinal direction preferably not in parallel to a direction of thickness of the resin molded product. The resin molded product molded in a shape of a parallelepiped often receives external impact (stress) in a direction in parallel to the direction of thickness thereof. In this case, in the resin molded product in which the longitudinal direction of at least one of the plant fibers is not in parallel to the direction of thickness of the resin molded product, friction force between resin 1 and plant fibers 2 can act without exception by the time of break. Therefore, the resin molded product can have further improved impact resistance as compared with a composition consisting of resin 1.

In the resin molded product herein molded in a shape of a parallelepiped, so long as the effect of the present invention is achieved, at least one of plant fibers in the resin molded product can be considered to have a longitudinal direction not in parallel to the direction of thickness of the resin molded product, because, when the longitudinal direction of all plant fibers in the resin molded product is in parallel to the direction of thickness of the resin molded product, friction force between the resin and the plant fibers is difficult to act. Therefore, by checking whether or not the resin molded product molded in the shape of the parallelepiped has an effect of improved impact resistance as compared with the resin molded product consisting of the resin, the longitudinal direction of at least one of the plant fibers not being in parallel to the direction of thickness of the resin molded product can be determined.

Impact resistance of the resin molded product according to the present embodiment can be measured by determining a value of Izod impact strength in conformity with the test method defined under JIS K 7110: 1999. Therefore, in the present embodiment, whether or not a resin molded product has improved impact resistance as compared with a resin molded product not containing plant fibers but consisting of a resin can be checked by determining values of Izod impact strength of resin molded products and comparing the values. When the resin molded product containing the fiber-reinforced resin composition according to the present embodiment has improved impact resistance as compared with the resin molded product not containing the plant fibers but consisting of the resin, σr, σrf, and σf are regarded as satisfying relation of σr<σrf<σf in the fiber-reinforced resin composition contained in the resin molded product.

The resin molded product according to the present embodiment can be manufactured by molding the fiber-reinforced resin composition obtained by the manufacturing method described above by using a conventionally known molding method such as injection molding and extrusion molding, without particularly being restricted. From a point of view of convenience of use, the resin molded product according to the present embodiment is preferably manufactured by injection molding through the injection molding step as described above.

The resin molded product according to the present embodiment can also be manufactured by introducing pellets obtained by compressing and pelletizing a resin and plant fibers and an additive added as necessary or a crushed material obtained by crushing the resin, the plant fibers, and the additive into the injection molding machine described above. Specifically, a resin molded product can be manufactured by introducing the pellets or the crushed material into the cylinder through a hopper of the injection molding machine described above, melting and mixing and kneading them in the cylinder at the temperature described above, and then injecting them into a mold.

[Electrophotograph Forming Apparatus]

An electrophotograph forming apparatus according to the present embodiment includes the resin molded product described above. The resin molded product can have improved impact resistance as compared with a resin molded product consisting of a resin that makes up the fiber-reinforced resin composition as described above. Therefore, the electrophotograph forming apparatus according to the present embodiment can exhibit resistance against various types of external impact.

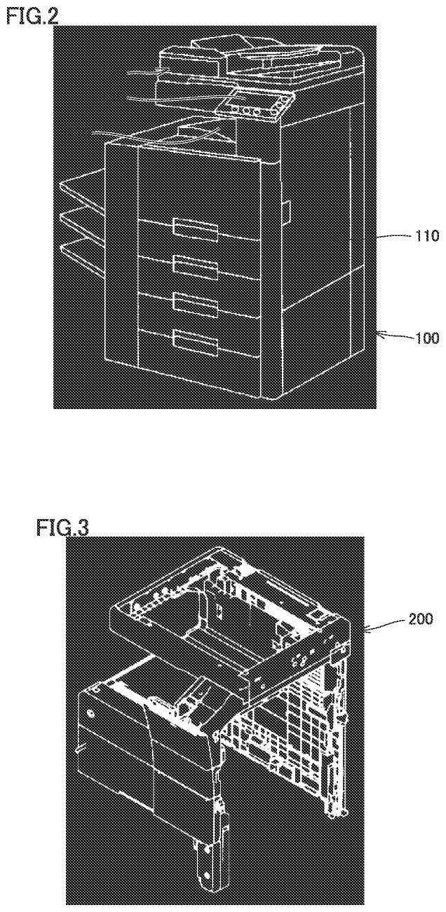

An image forming apparatus implemented as what is called an electrophotographic multi-functional peripheral (MFP) is preferably adopted as the electrophotograph forming apparatus according to the present embodiment. For example, as shown in FIG. 2, an electrophotograph forming apparatus 100 includes a print engine 110, a document reader 120, an ejection tray 130, and a liquid crystal screen 140.

In electrophotograph forming apparatus 100, document reader 120 reads a document by means of an image scanner mounted on document reader 120 and outputs a result of reading as an input image to print engine 110. Print engine 110 provides full-color print output through an electrographic image forming process. A printed and output medium is ejected to ejection tray 130. Liquid crystal screen 140 shows information to a user. Liquid crystal screen 140 as a touch panel can also accept an operation from a user. Electrophotograph forming apparatus 100 is applicable also to formation of a monochrome image, without being limited to formation of a color image.

In such an electrophotograph forming apparatus 100, the resin molded product can be used, for example, as various housings such as a waste toner box, a development housing, or a paper feed guide, a manual feed tray, a cover, or a rail.

[Exterior Component for Electrophotograph Forming Apparatus]

An exterior component for an electrophotograph forming apparatus according to the present embodiment includes the resin molded product described above. For example, as shown in FIG. 3, the exterior component for the electrophotograph forming apparatus can be used as a housing 200 of electrophotograph forming apparatus 100 shown in FIG. 2. External impact may be applied to housing 200 by contact with a person and an object. Therefore, the resin molded product having improved impact resistance is suitably used.

<Snap Fit Structure>

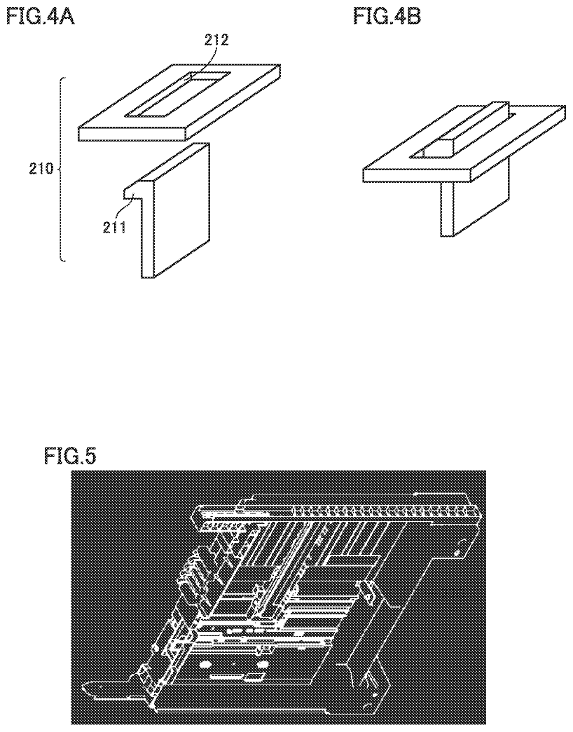

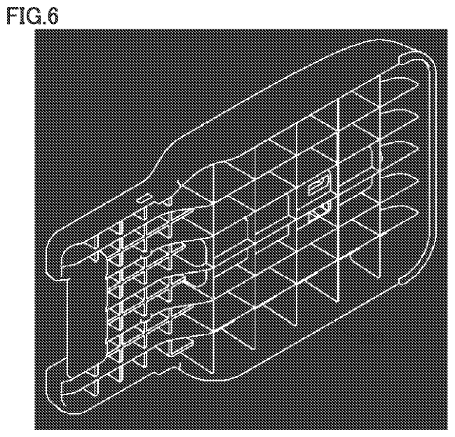

The exterior component for the electrophotograph forming apparatus according to the present embodiment preferably includes, for example, a snap fit structure 210 as shown in FIGS. 4A and 4B. “Snap fit” of the snap fit structure refers to a kind of a mechanical joint method used for coupling of a metal component and a plastic component, and to a method of fixing by fitting the metal component and the plastic component by making use of elasticity of a material. Specifically, as shown in FIGS. 4A and 4B, this method is mechanical fixing by hooking by fitting a hook-shaped projection 211 at a tip end of a leaf spring into a recess 212 in a component to be fixed by making use of elasticity of the material.

The snap fit structure of the exterior component for the electrophotograph forming apparatus is not limited to the snap fit structure of such a type as providing hook-shaped projection 211 at the tip end of the leaf spring described above, and conventionally known all types of snap fit structures are applicable. For example, a snap fit structure of such a type as providing a projecting holder around a cylinder or a ball-and-socket type like a ball joint is applicable. Since the snap fit structure fixes by fitting the metal component and the plastic component by making use of elasticity of a material, external impact may be applied to the snap fit structure at the time of fixing thereof. Therefore, the resin molded product having improved impact resistance is suitably used.

<Paper Feed Cassette>

The exterior component for the electrophotograph forming apparatus according to the present embodiment is preferably a paper feed cassette 220, for example, as shown in FIG. 5. Paper feed cassette 220 is provided as an internal component of print engine 110 in electrophotograph forming apparatus 100 shown in FIG. 2. A plurality of sheets of paper are placed in paper feed cassette 220, and each time print output is performed in print engine 110, the sheets of paper are transported one by one to a paper transportation path by a paper feed roller. External impact may be applied to paper feed cassette 220 when it is accommodated in print engine 110. Therefore, the resin molded product having improved impact resistance is suitably used.

<Support Component>

The exterior component for the electrophotograph forming apparatus is preferably a support component 230 that is arranged at the bottom of the electrophotograph forming apparatus and supports the electrophotograph forming apparatus, for example, as shown in FIG. 6. Support component 230 can support electrophotograph forming apparatus 100 by being arranged at the bottom as described above in electrophotograph forming apparatus 100 shown in FIG. 2 (FIG. 2 not showing the support component). External impact is constantly applied to support component 230 for supporting the electrophotograph forming apparatus. Furthermore, external impact may be applied also when the electrophotograph forming apparatus is moved. Therefore, the resin molded product having improved impact resistance is suitably used.

### Examples

Though the present invention will be described below in further detail with reference to Examples, the present invention is not limited thereto.

[Manufacturing of Fiber-Reinforced Resin Molded Product]

<Sample 1>

A resin molded product as a sample 1 made of a specimen defined under JIS K 7110 was obtained by preparing 95 mass % of SUMITOMONOBLEN™ Grade W101 as the resin manufactured by Sumitomo Chemical Co., Ltd. and composed of polypropylene representing a thermoplastic resin (which is also denoted as a “resin A” below) and 5 mass % of Tencel™ as the plant fiber having fineness of 1.7 dtex and a length of 4 mm and manufactured by Lenzing Fibers (which is also denoted as a “plant fiber A” below), introducing them into an injection molding machine (a trademark “J110AD” manufactured by The Japan Steel Work, Ltd.), and injecting them from a cylinder to a mold. A temperature of the mold was set to 50° C. in injection molding by using the injection molding machine.

<Control Sample 1>

A resin molded product as a control sample 1 made of a specimen identical in shape to the resin molded product as sample 1 was obtained by injection molding of a resin consisting of 100 mass % of resin A by using the injection molding machine. A temperature condition of the cylinder and the mold in injection molding by using the injection molding machine was the same as that for sample 1.

<Sample 2>

A resin molded product as a sample 2 made of a specimen identical in shape to the resin molded product as sample 1 was obtained by preparing 95 mass % of SUMITOMONOBLEN™ Grade FS2011DG3 as the resin manufactured by Sumitomo Chemical Co., Ltd. and composed of polypropylene representing a thermoplastic resin (which is also denoted as a “resin B” below) and 5 mass % of plant fiber A, introducing them into the injection molding machine, and injecting them from a cylinder to a mold. A temperature of the mold was the same as that for sample 1 in injection molding by using the injection molding machine.

<Control Sample 2>

A resin molded product as a control sample 2 made of a specimen identical in shape to the resin molded product as sample 2 was obtained by injection molding of a resin consisting of 100 mass % of resin B by using the injection molding machine. A temperature condition of the cylinder and the mold in injection molding by using the injection molding machine was the same as that for sample 2.

[Evaluation of Physical Property]

<Calculation of Value of Izod Impact Strength>

A value (unit of kJ/m²) of Izod impact strength of the resin molded product as each of sample 1, control sample 1, sample 2, and control sample 2 was determined in conformity with the test method defined under JIS K 7110: 1999. Table 1 shows results. The resin molded product is evaluated as being higher in impact resistance as the value of Izod impact strength is larger. Sample 1 corresponds to Example and sample 2 not satisfying the expression (1) corresponds to Comparative Example.

TABLE 1

| | | Sample 1 | Control Sample 1 | Sample 2 | Control Sample 2 |
|---|---|---|---|---|---|
| Material | Plant Fiber | Plant Fiber A | — | Plant Fiber A | — |
| | Resin | Resin A | Resin A | Resin B | Resin B |
| Formulation | Ratio of Plant Fiber | 5 | 0 | 5 | 0 |
| | [mass %] | | | | |
| | Ratio of Resin | 95 | 100 | 95 | 100 |
| | [mass %] | | | | |
| Physical | Izod Impact Strength | 8.7 | 4.4 | 4.9 | 5.9 |
| Property | Value [kJ/m²] | | | | |
| Value | | | | | |

<Discussion>

As is clear from Table 1, the resin molded product as sample 1 representing Example is evaluated as excellent in impact resistance because it is larger in value of Izod impact strength than the resin molded product as control sample 1. The resin molded product as sample 2 representing Comparative Example is understood as not having improved impact resistance by addition of the plant fiber to the resin because it is smaller in value of Izod impact strength than the resin molded product as control sample 2.

Although embodiments of the present invention have been described and illustrated in detail, the disclosed embodiments are made for the purposes of illustration and example only and not limitation. The scope of the present invention should be interpreted by terms of the appended claims

What is claimed is:

1. A fiber-reinforced resin composition comprising:
a resin; and
plant fibers dispersed in the resin,
at least a part of the resin being in direct contact with at least a part of a surface of the plant fibers,
σr, σrf, and σf satisfying relation expressed in an expression (1)
σr<σrf<σf (1)
where σr represents tensile strength of the resin, σrf represents interfacial shear stress between the resin and the plant fibers, and σf represents tensile strength of the plant fibers.

2. The fiber-reinforced resin composition according to claim 1, wherein
the resin is a thermoplastic resin.

3. The fiber-reinforced resin composition according to claim 1, wherein
the resin has both or any one of a glass transition temperature and a melting point not higher than a decomposition start temperature of the plant fibers.

4. The fiber-reinforced resin composition according to claim 1, containing at least 0.1 mass % and at most 50 mass % of the plant fibers.

5. A resin molded product containing the fiber-reinforced resin composition according to claim 1.

6. The resin molded product according to claim 5, wherein
when the resin molded product is formed into a shape of a parallelepiped, at least one of the plant fibers has a longitudinal direction not in parallel to a direction of thickness of the resin molded product.

7. An electrophotograph forming apparatus comprising the resin molded product according to claim 5.

8. An exterior component for an electrophotograph forming apparatus comprising the resin molded product according to claim 5.

9. The exterior component for an electrophotograph forming apparatus according to claim 8, comprising a snap fit structure.

10. The exterior component for an electrophotograph forming apparatus according to claim 8, the exterior component being a paper feed cassette.

11. The exterior component for an electrophotograph forming apparatus according to claim 8, the exterior component being a support component that supports the electrophotograph forming apparatus, the support component being arranged at a bottom of the electrophotograph forming apparatus.
